(19) United States
(12) Patent Application Publication
(10) Pub. No.: US 2022/0174944 A1
(43) Pub. Date: Jun. 9, 2022

(54) SUN PROTECTANT FOR CROP PLANTS

(71) Applicant: Globachem NV, Sint-Trudien (BE)

(72) Inventors: Francis Claes, Sint-Truiden (BE); Guy Van Daele, Sint-Truiden (BE)

(73) Assignee: Globachem NV, Sint-Trudien (BE)

(21) Appl. No.: 17/599,348

(22) PCT Filed: Mar. 18, 2020
(86) PCT No.: PCT/EP2020/057521

§ 371 Date: Sep. 28, 2021

(30) Foreign Application Priority Data
Mar. 29, 2019 (EP) 19020239.0

(51) Int. Cl. A01N 3/00; A01N 65/03

(52) U.S. Cl. CPC A01N 3/00; A01N 65/03

(57) ABSTRACT

The present invention relates to the compositions comprising algae, specifically Spirulina platensis and Chlorella, and their use for the treatment of crops, such as fruits, vegetables and arable crops against heat stress, especially sunburn.

### FIELD OF THE INVENTION

The present invention relates to the compositions comprising algae and their use for the treatment of crops, such as fruits, vegetables and arable crops, against heat stress, especially sunburn.

### BACKGROUND OF THE INVENTION

Heat stress, especially sunburn, is a serious problem, most prominent in the areas where high temperatures and solar radiation are combined, which affects the quality of fruits, vegetables and arable crops and can account for losses of up to 40 percent of the crops such as melons, squash, tomatoes, peppers, eggplants, cucumbers, apples, strawberries, and brambles.

When fruit, or vegetable, is exposed to excessive heat and light from the sun, the skin can turn brown or black. Severe heat injury can often cause a surface crack and complete tissue decay.

Drought stress may further contribute to sunburn by reducing foliar shading and fruit size.

There are three types or gradations of sunburn which affect the crops.

First, sunburn necrosis, is caused on the sun exposed side of the crop where skin, peel, and crop tissue start to die out. Integrity of the cell membrane is lost, and cells start to leak their contents (electrolytes). Injury may be white to brown in color, and such crops are not marketable.

The critical crop tissue temperature for sunburn necrosis varies with the type of the crop. Some research papers have shown that the crop skin temperature threshold for sunburn necrosis is from about 38 to about 40° C. for cucumbers; from about 40 to about 43° C. for peppers, and from about 50 to about 53° C. for apples.

Second type is sunburn browning which is also the most prevalent one. Crops affected with sunburn browning may be marketable but will be of a lower grade.

This sunburn causes loss of pigmentation resulting in a yellow, bronze, or brown spot on the sun exposed side of the crop due to pigments being destroyed or denatured.

This type of sunburn browning occurs at temperatures of about 5° C. lower than the ones needed for sunburn necrosis.

The third type of sunburn is the photo-oxidative sunburn. This type of sunburn happens when shaded crops are suddenly exposed to sunlight, for example after late pruning or after severe weather when leaf cover is suddenly lost.

The crops are photobleached by the sudden excess of light because they are not acclimatized to the high light levels, and crop tissue starts to die. Damaged tissue is often white in color.

This type of sunburn occurs even at lower temperatures than the other types of sunburn.

Sunburn crop management consists of several options, however all of them suffer from some disadvantages.

First option is overhead or evaporative cooling (EC) where the crop surface is cooled by direct application of cold water. It is a reliable technique, but significant investments are needed to install, operate and maintain the cooling system.

In crops with large percentages of exposed crops at risk of sunburn, protective netting is an option. However, this is not practical for large acreages as the cost of the infrastructure is high.

Market currently offers few products used for the sunburn protection of crops at a field scale:

Surrounds contains kaolin which forms a white barrier coating on crops when applied and protects them from sunburn and heat stress.

Screen Duo™ consists of hydrous kaolin (aluminum silicate) and when applied to crop forms a visible particle film which reflects harmful UV and IR light and reduces the temperature of the crop.

Purshade® contains calcium carbonate and acts as a protective film against harmful solar radiation.

Parke™ is a blend of phospholipids in a cellulosic matrix designed to supplement the cuticle of growing fruit and foliage. It is used to reduce micro-fractures and minimize the fruit cracking as well as to provide protection from sunburn.

Raynox® comprises water, carnauba wax, organically modified clay and emulsifiers, and is used to protect apples from sunburn browning.

Products based on kaolin clay, calcium carbonate or talc, such as Surround, Screen Duo and Purshade, when applied, leave a white particle film on the crop which is associated with some drawbacks. Namely, added cost of washing and cleaning (i.e. brushing) of crops at or post-harvest. Furthermore, hard-to-reach places of the crop such as calyx, stem end and creases may still contain traces of the product even after washing.

Furthermore, when overhead irrigation is used, or during rainy weather, the material can be partially washed off, thereby reducing effectiveness and requiring additional applications.

Produce buyers can also have standards relating to the use of particle films and may not accept products with visible residues.

It is therefore an object of the invention to provide a product that may alleviate the disadvantages of the prior art and provide an efficient solution for crop protection from heat stress, especially sunburn.

The present invention provides compositions and their use for the treatment of crops, such as fruits, vegetables and arable crops, against heat stress, especially sunburn, wherein algae is the main component of such compositions.

At the moment, algae or specifically Spirulina platensis, as a representative of algae, is only known in agriculture as a fertilizer.

### SUMMARY OF THE INVENTION

According to the present invention, provided are compositions comprising algae or mixtures thereof for use as a crop treatment against heat stress, especially sunburn heat stress.

According to the present invention algae is selected from Spirulina and Chlorella and mixtures thereof.

Such compositions provide the advantage of effective heat stress protection of crops without any residue issues and need for cleaning of crops pre- or post-harvest.

The compositions according to the present invention can further comprise one or more ingredients selected from osmoprotectants, elicitors, binding agents and auxiliaries, and any mixtures thereof.

Furthermore, compositions according to the present invention can be supplied as liquid compositions, where only dilution step is required, or can be provided in a powder form or as granulated product wherein step of dissolving the powder or granules in a suitable solvent, such as water, and optionally dilution step, are needed.

Kits comprising compositions according to the present invention are disclosed herein. Kits can also further comprise suitable solvents and mixtures thereof.

Furthermore, provided herein is a method for protecting the crops against heat stress is, and the use of algae for heat stress protection.

Other aspects of the present invention are further described in the following sections.

### DETAILED DESCRIPTION OF THE INVENTION

Following abbreviations with the following meaning are used:

DAA=days after first application of treatment
SP=Spirulina platensis
EC=ectoine
AC=lambda-carrageenan
BE=betaine

### LYS=L-lysine

Composition and formulation are terms herein used interchangeably as having the same meaning.

### Materials and Methods

Compositions comprising Spirulina, as a representative of algae, alone or mixed with other ingredients were prepared by dissolving commercially available freeze-dried Spirulina platensis in predetermined amount of water to obtain solutions with predetermined concentrations of Spirulina.

All other ingredients, depending on the composition in question, were added sequentially to the solution to be present in the predetermined concentrations as illustrated by the examples.

Two control arms, for the purpose of efficacy comparison, were followed:

Control was the arm where no treatment was applied to observe the effect and extent of sunburn on unprotected crops.

Second control—Surround or Parka, was the arm were currently market-available compositions were applied, namely Surround (calcined kaolin particle film) or Parka (a blend of phospholipids in a cellulosic matrix).

### EXAMPLES

The following examples illustrate the compositions according to the present invention and their efficacy in heat stress protection of crops.

### Example 1. Mango Fruit, Trial 1

Test location: Thailand

### Cultivar: Nam Dok Mai

Mango plots 4 m×12 m=48 m², 4 plot repetitions
Spray solutions were prepared as following:
Surround: 10 000 grams of market available product Surround was dispersed in 1200 L of water
SP: 1500 grams of freeze-dried Spirulina platensis was dispersed in 1200 L of water
SP+EC: 1500 grams of freeze-dried Spirulina platensis was dispersed in 1200 L of water with addition of 400 ml of ectoine solution of 2 g/L concentration
SP+BE: 1500 grams of freeze-dried Spirulina platensis was dispersed in 1200 L of water with addition of 700 ml of betaine dispersion of 360 g/L concentration

### Application Dates and Weather Conditions:

| Application | Application | Relative | Air | Cloud |
|---|---|---|---|---|
| date | time | humidity | temperature | coverage |
| 10/04 | 9 h 30 | 55% | 28° C. | 10% |
| 17/04 | 9 h 45 | 65% | 28° C. | 5% |
| 24/04 | 9 h 30 | 81% | 30° C. | 10% |

### Application Equipment:

Motorized sprayer—hollow cone

### Assessment Protocol:

Before the first application of treatment, severity data of affected fruit were estimated visually as the percentage of specified mango fruit that was affected by insects and disease. The number of affected fruits were counted on 20 plants per plot.

| Composition | Spray solution concentration | Dose | Dosage |
|---|---|---|---|
| Ingredients | of the ingredients g/L | g/ha | regimen |
| Surround | 8.33 | 10 000 | sprayed 3 |
| SP | 1.25 | 1500 | times in 7 days |
| SP + | 1.25 + | 1500 + | intervals |
| EC | 0.000667 | 0.8 | |
| SP + | 1.25 + | 1500 + | |
| BE | 0.21 | 252 | |

### Results:

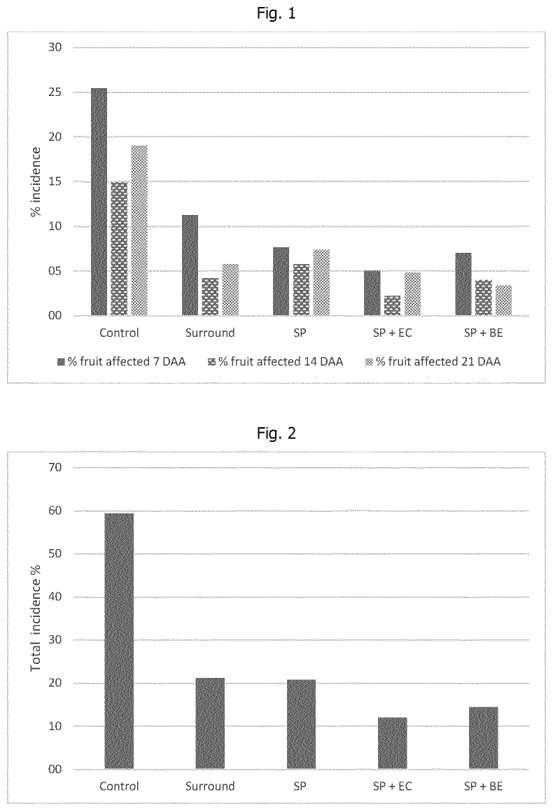

FIG. 1. Sunburn incidence
FIG. 2. Total sunburn incidence—30 days after first application
FIG. 3. Surface damage intensity—30 days after first treatment

### Example 2. Mango Fruit, Trial 2

Test location: Thailand

### Cultivar: Nam Dok Mai

Mango plots 4 m×12 m=48 m², 4 plot repetitions
Spray solutions per ha:
Surround: 10 000 grams of market available product Surround was dispersed in 1200 L of water
SP+AC: 1500 grams of freeze-dried Spirulina platensis was dispersed in 1200 L of water and 500 ml of lambda-carrageenan solution of 2 g/L concentration was added
SP+LYS: 1500 grams of freeze-dried Spirulina platensis dispersed in 1200 L of water and 2000 ml of L-lysine solution of 50 g/L concentration was added
SP+BE+AC+EC: 1500 grams of freeze-dried Spirulina platensis dispersed in 1200 L of water with addition of 700 ml of betaine dispersion of 360 g/L concentration, 500 ml of lambda-carrageenan solution of 2 g/L concentration and 2000 ml of L-lysine solution of 50 g/L concentration

### Application Dates and Weather Conditions:

| Application | Application | Relative | Air | Cloud |
|---|---|---|---|---|
| date | time | humidity | temperature | coverage |
| 11/04 | 9 h 30 | 64% | 28° C. | 5% |
| 18/04 | 9 h 00 | 65% | 28° C. | 5% |
| 25/04 | 9 h 10 | 60% | 27° C. | 5% |

### Application Equipment:

Motorized sprayer—hollow cone

### Assessment Protocol:

Before the first application of treatment, severity data of affected fruit were estimated visually as the percentage of specified mango fruit that was affected by insects and disease. The number of affected fruits were counted on 20 plants per plot.

| Composition | Spray solution concentration | Dose | Dosage |
|---|---|---|---|
| Ingredients | of the ingredients g/L | g/ha | regimen |
| Surround | 8.33 | 10000 | sprayed 3 |
| SP + | 1.25 + | 1500 + | times in 7 days |
| AC | 0.000833 | 1 | intervals |
| SP + | 1.25 + | 1500 + | |
| LYS | 0.0833 | 100 | |
| SP + | 1.25 + | 1500 + | |
| BE + | 0.21 + | 252 + | |
| AC + | 0.000833 + | 1 + | |
| EC | 0.000667 | 0.8 | |

### Results:

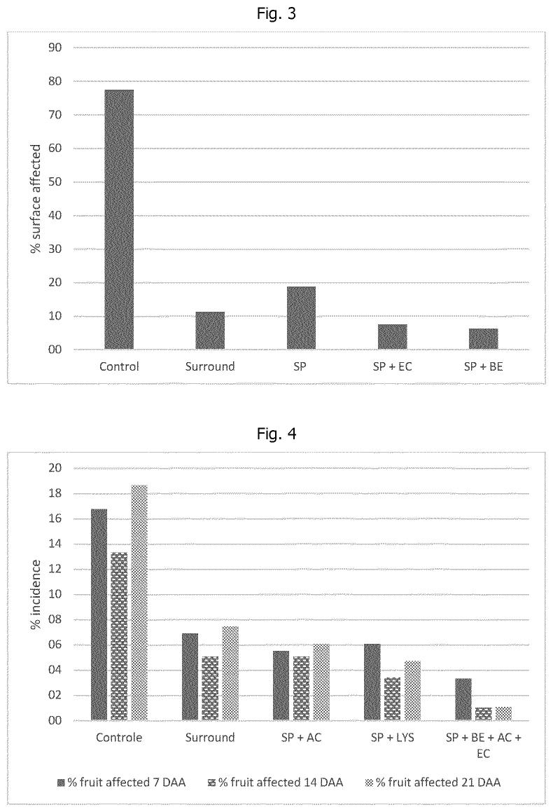

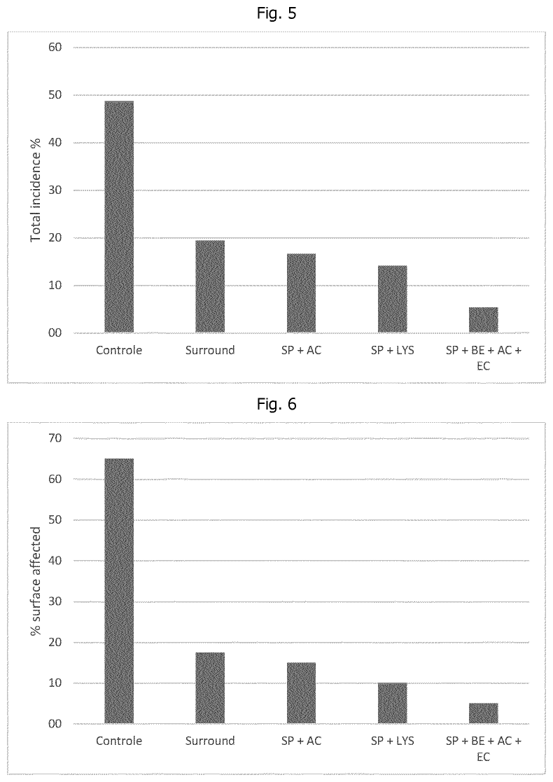

FIG. 4. Sunburn incidence
FIG. 5. Total sunburn incidence—30 days after first application
FIG. 6. Surface damage intensity—30 days after first treatment

### Example 3. Apple Fruit, Trial 1

Test location: Europe

### Cultivar: Apache

Plots: 7.25 m×3.5 m=21.8 m², 4 plot repetitions
Spray solutions per Ha:
Surround: 10 000 grams of market available product Surround was dispersed in 500 L of water
SP: 1500 grams of freeze-dried Spirulina platensis was dispersed in 500 L of water
SP+BE: 1500 grams of freeze-dried Spirulina platensis was dispersed in 500 L of water and 700 ml of betaine dispersion of a concentration of 360 g/L was added
SP+EC: 1500 grams of freeze-dried Spirulina platensis was dispersed in 500 L of water and 400 ml of ectoine solution of a concentration of 2 g/L was added
SP+AC: 1500 grams of freeze-dried Spirulina platensis was dispersed in 500 L of water and 500 ml of lambda-carrageenan solution of 2 g/L concentration was added

### Application Dates and Weather Conditions:

| Application | Application | Relative | Air | Cloud |
|---|---|---|---|---|
| date | time | humidity | temperature | coverage |
| 26/06 | 8 h 00 | 53% | 24° C. | 10% |
| 09/07 | 11 h 00 | 47% | 24° C. | 50% |
| 24/07 | 10 h 30 | 50% | 25° C. | 5% |

### Application Equipment:

Motorized sprayer—hollow cone

### Assessment Protocol:

The number of affected fruits were counted 3 middle trees of each plot, on both sides. The affected fruits were not removed during the assessments. Before the first application, no sunburn damage was observed.

| Composition | Spray solution concentration | Dose | Dosage |
|---|---|---|---|
| Ingredients | of the ingredients g/L | g/ha | regimen |
| SP | 3.00 | 1500 | sprayed 3 |
| SP + | 3.00 + | 1500 + | times in 15 |
| BE | 0.504 | 252 | days intervals |
| SP + | 3.00 + | 1500 + | |
| EC | 0.0016 | 0.8 | |
| SP + | 3.00 + | 1500 + | |
| AC | 0.0020 | 1 | |

### Results:

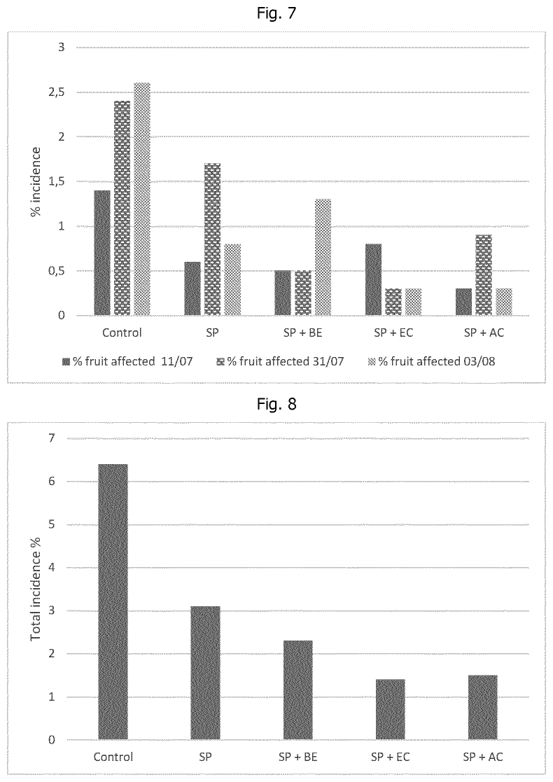

FIG. 7. Sunburn incidence
FIG. 8. Total sunburn incidence—43 days after first application

### Example 4. Apple Fruit, Trial 2

Test location: Europe
Cultivar: Golden delicious
Plots: 7.25 m×3.5 m=21.8 m², 4 plot repetitions
Spray solutions per Ha:
Surround: 10 000 grams of market available product Surround was dispersed in 500 L of water
SP+BE+AC: 1500 grams of freeze-dried Spirulina platensis dispersed in 500 L of water with addition of 700 ml of betaine dispersion of 360 g/L concentration and 500 ml of lambda-carrageenan solution of 2 g/L concentration
SP+BE+EC: 1500 grams of freeze-dried Spirulina platensis dispersed in 500 L of water with addition of 700 ml of betaine dispersion of 360 g/L concentration and 400 ml of ectoine solution of 2 g/L concentration
SP+AC+EC: 1500 grams of freeze-dried Spirulina platensis dispersed in 500 L of water with addition of 500 ml of lambda-carrageenan solution of 2 g/L concentration and 400 ml of ectoine solution of 2 g/L concentration

### Application Dates and Weather Conditions:

| Application | Application | Relative | Air | Cloud |
|---|---|---|---|---|
| date | time | humidity | temperature | coverage |
| 26/06 | 8 h 00 | 53% | 24° C. | 10% |
| 09/07 | 11 h 00 | 47% | 24° C. | 50% |
| 24/07 | 10 h 30 | 50% | 25° C. | 5% |

### Application Equipment:

Motorized sprayer—hollow cone

### Assessment Protocol:

The number of affected fruits were counted on 3 trees of each plot, on both sides.
The affected fruits were not removed during the assessments.
Before the first application, no sunburn damage was observed.

| Composition | Spray solution concentration | Dose | Dosage |
|---|---|---|---|
| Ingredients | of the ingredients g/L | g/ha | regimen |
| Surround | 20.00 | 10000 | sprayed 3 |
| SP + | 3.00 + | 1500 + | times in 15 |
| BE + | 0.504 + | 252 + | days intervals |
| AC | 0.0020 | 1 | |
| SP + | 3.00 + | 1500 + | |
| BE + | 0.504 + | 252 + | |
| EC | 0.0016 | 0.000833 | |
| SP + | 3.00 + | 1500 + | |
| AC + | 0.0020 + | 1 + | |
| EC | 0.0016 | 0.8 | |

### Results:

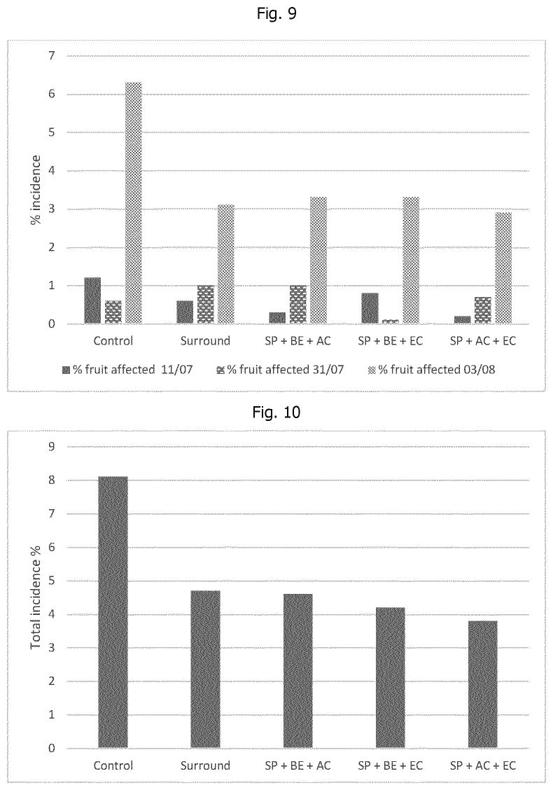

FIG. 9. Sunburn incidence
FIG. 10. Total sunburn incidence—43 days after first application

### Example 5. Apple Fruit, Trial 3

Test location: USA

### Cultivar: Gala

Plots: 5 m×7 m=35 m², 4 plot repetitions
Spray solutions per ha:
Parka: 10 L of the market available product emulsified in 400 L of water
SP: 1500 grams of freeze-dried Spirulina platensis dispersed in 400 L of water
SP+BE: 1500 grams of freeze-dried Spirulina platensis dispersed in 400 L of water and 700 ml of betaine dispersion of 360 g/L concentration added
SP+AC: 1500 grams of freeze-dried Spirulina platensis dispersed in 400 L of water, followed by addition of 500 ml of lambda-carrageenan solution of 2 g/L concentration

### Application Dates:

| Application | Application | Relative | Air | Cloud |
|---|---|---|---|---|
| date | time | humidity | temperature | coverage |
| 05/07 | 8 h 30 | 30% | 82° F. | 10% |
| 19/07 | 9 h 00 | 40% | 75° F. | 20% |
| 27/07 | 9 h 00 | 20% | 88° F. | 10% |

### Application Equipment:

Motorized sprayer—hollow cone

### Assessment Protocol:

100 fruits per tree were inspected, and the affected fruits were counted.

| Composition | Spray solution concentration | Dose | Dosage |
|---|---|---|---|
| Ingredients | of the ingredients g/L | g/ha | regimen |
| Parka | 25 ml/L | 10000 ml | sprayed 3 |
| SP | 3.75 | 1500 | times in 12 |
| SP + | 3.75 + | 1500 + | days intervals |
| BE | 0.63 | 252 | |
| SP + | 3.75 + | 1500 + | |
| AC | 0.0025 | 1 | |

### Results:

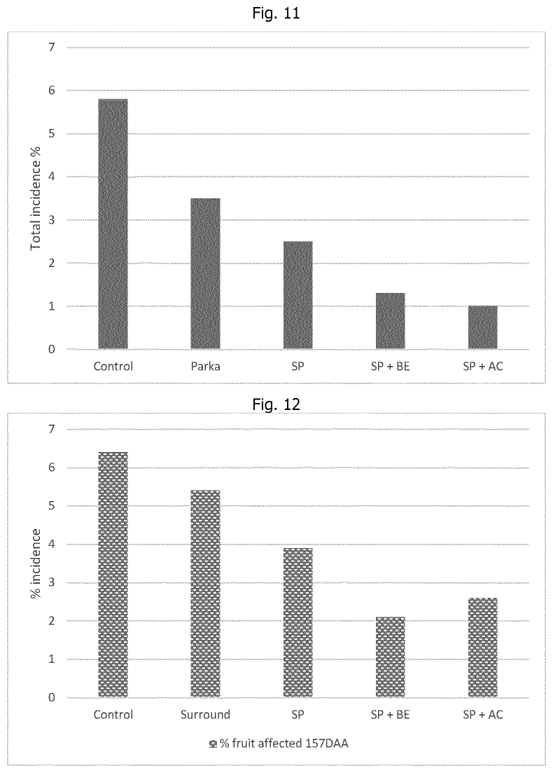

FIG. 11. Total sunburn incidence—55 days after first application

### Example 6. Citrus

Test location: USA
Cultivar: Citrus tangerine/Fairchild seedless
Plots: 7 m×7 m=49 m², 4 plot repetitions
Spray solutions per ha:
Surround: 10 kg dispersed in 1000 L of water
SP: 1500 grams of freeze-dried Spirulina platensis dispersed in 1000 L of water
SP+BE: 1500 grams of freeze-dried Spirulina platensis dispersed in 1000 L of water and 700 ml of betaine dispersion at a concentration of 360 g/L added
SP+AC: 1500 grams of freeze-dried Spirulina platensis dispersed in 1000 L of water and 500 ml of lambda-carrageenan solution at a concentration of 2 g/L added

### Application Dates:

| Application | Application | Relative | Air | Cloud |
|---|---|---|---|---|
| date | time | humidity | temperature | coverage |
| 25/06 | 12 h 00 | 12% | 103° F. | 10% |
| 09/07 | 13 h 00 | 42% | 96° F. | 100% |

### Application Equipment:

Bacman flat fan sprayer—nozzle size 8002—compressed CO₂ as propellant

### Assessment Protocol:

All fruits on the trees were counted, and the percentage of affected fruits was calculated.

| Composition | Spray solution concentration | Dose | Dosage |
|---|---|---|---|
| Ingredients | of the ingredients g/L | g/ha | regimen |
| Surround | 15 | 15000 | sprayed 2 |
| SP | 1.5 | 1500 | times in 15 |
| SP + | 1.5 + | 1500 + | days interval |
| BE | 0.252 | 252 | |
| SP + | 1.5 + | 1500 + | |
| AC | 0.001 | 1 | |

### Results:

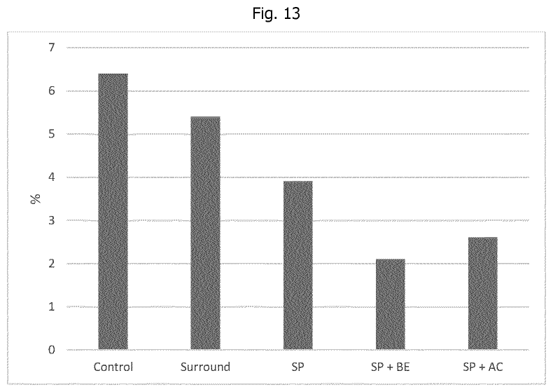

FIG. 12. Sunburn incidence
FIG. 13. Total sunburn incidence—157 days after first application
As it is visible from the results obtained, Spirulina either alone or in combination with other ingredients, provides good results in protection of various crops against heat stress.

### Compositions

The features and characteristics illustrated and/or described herein in connection with various examples and/or compositions presented herein may be combined with the features and characteristics of other examples and/or compositions, also provided herein respectively, and such modifications and variations are intended to be included within the scope of the present invention.

Compositions according to the present invention comprise algae selected from Spirulina and Chlorella, and mixtures thereof.

The compositions according to the present invention can further comprise one or more ingredients selected from osmoprotectants, and/or elicitors and/or binding agents.

According to the present invention, osmoprotectants are selected from betaine, ectoine, trehalose, amino acids selected from proline, lysine, glutamic acid, cysteine and glycine; elicitors are selected from auxins, gibberellins, salicylic acid, methyl salicylate, jasmonic acid, benzoic acid, chitosan, beta-glucans and carrageenans (such as lambda-carrageenan); binding agents are selected from arabic gum, xanthan gum, diutan gum, cellulose and alginates, waxes such as carnauba wax or candelilla wax, and contemplated herein are any mixtures thereof.

The herein disclosed compositions can further comprise one or more agriculturally acceptable adjuvant or auxiliary.

An adjuvant or an auxiliary in the context of the present invention is a component which enhances the performance effect of the formulation.

Examples of adjuvants and auxiliaries are agents which promote one or more of the following effects: retention, spreading, attachment to the leaf/crop surface, penetration, physical, chemical, technical and/or biological effect, etc.

One aspect of the present invention is to provide compositions as described above additionally comprising at least one auxiliary component selected from the group comprising of emulsifiers, solvents, surfactants, carriers, dispersants, thickeners, hydrophobizing agents, moisture-retaining agents, extenders, solid carriers, anti-foaming agents and/or other auxiliaries.

The compositions of the present invention can be formulated into any customary type of agrochemical compositions, e. g. solutions, emulsions, suspensions, dusts, powders, pastes, granules, pressings, capsules, and mixtures thereof.

Composition types examples are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP), pressings (e.g. BR, TB), granules (e.g. WG, SG, GR), etc.

According to the present invention, compositions disclosed herein can be provided as liquid compositions and/or powder and/or granules.

For example, liquid compositions, as contemplated herein, but without limitation to herein provided examples, are the following:
liquid composition of one or more algae;
liquid composition comprising one or more algae and one or more ingredients selected from elicitors, osmoprotectants, auxiliaries and any mixture thereof;
liquid composition of one or more algae in one container supplied with the second container comprising liquid compositions of one or more ingredients selected from elicitors, osmoprotectants and auxiliaries, and mixtures thereof.

Furthermore, powder and/or granule forms can be provided as:
powder and/or granule composition of one or more algae;
powder and/or granule composition comprising one or more algae and one or more ingredients selected from elicitors, osmoprotectants, binding agents and auxiliaries, and mixtures thereof;
powder and/or granule composition of one or more algae in one container supplied with the second container comprising powder and/or granule composition of one or more ingredients selected from elicitors, osmoprotectants, binding agents and auxiliaries, and mixtures thereof.

Liquid compositions as described above can be prepared, for example, by mixing selected algae and/or other ingredients, as described herein, in a suitable solvent and/or diluent.

One example of a suitable solvent and/or diluent according to the present invention is water.

Furthermore, any liquid composition as above can be supplied with any powder and/or granule composition as disclosed above and vice versa.

Any of the above-mentioned compositions can be supplied as a kit, for example but not meant to be limited to, liquid composition of one or more algae provided in one container supplied with the second container comprising powder and/or granule composition of one or more ingredients selected from elicitors, osmoprotectants, binding agents and auxiliaries, and mixtures thereof.

Any of the above-mentioned compositions and/or kits can be further supplied with any further agriculturally acceptable solvent and/or diluent.

All formulations described herein can be produced in a known manner, for example by mixing the active compounds with other ingredients and/or auxiliaries.

Methods for powder and/or granule preparations are well known in the prior art, for example as disclosed in paper by S. Shanmugam Granulation techniques and technologies: recent progresses, BioImpacts, 2015, 5(1), 55-63.

Whereas it is preferred to formulate commercial products as concentrates, the end user will normally use dilute formulations, and herein both concentrated and diluted compositions are contemplated and disclosed. Therefore, the content of the algae and/or osmoprotectants and/or elicitors and/or other auxiliaries prepared from the concentrate formulations may vary within wide ranges.

Compositions according to the present invention comprise algae in concentration of 1 g/L to 500 g/L.

Furthermore, when osmoprotectants and/or elicitors are present in the compositions according to the present invention, their concentration can vary from 0.0001 to 500 g/L.

Provided herein is a method for protecting crops against heat stress comprising the step of applying any of herein disclosed compositions to the crops.

Application on the crops takes place in a customary manner adapted to the application forms, for example liquid concentrates or granules can be mixed or dissolved respectively, in a suitable solvent and afterwards further diluted in a suitable diluent to the desired concentration and sprayed on the crops by diverse mechanical or manual sprayers.

The compositions according to the present invention have found its use in protection of crops against sunburn, wherein crops are selected from fruits, vegetables and arable crops.

Furthermore, fruits are selected from melons, apple, pears, mango, citrus, grape, peach, raspberry, gooseberry, cherries, kiwi; vegetables are selected from cucumbers, tomatoes and pumpkins; and arable crops are selected from potatoes, sugar beet, corn, oilseed rape, cereals and soybean.

According to the present invention, provided herein is a method for preparing heat stress protectant compositions, as disclosed herein, comprising a step of mixing algae with water.

1-17. (canceled)

18. An agricultural composition for treating a crop against heat stress, the agricultural composition comprising:
an algae or a mixture of algae; and
at least one ingredient selected from osmoprotectants, elicitors, binding agents, auxiliaries, and mixtures thereof.

19. The agricultural composition of claim 18, wherein the heat stress is sunburn.

20. The agricultural composition of claim 18, wherein:
the osmoprotectants are selected from betaine, ectoine, trehalose, proline, lysine, glutamic acid, cysteine, and glycine;
the elicitors are selected from auxins, gibberellins, salicylic acid, methyl salicylate, jasmonic acid, benzoic acid, chitosan, beta-glucans, and carrageenans;
the binding agents are selected from arabic gum, xanthan gum, diutan gum, cellulose, alginates, carnauba wax, and candelilla wax; and
the auxiliaries are selected from emulsifiers, solvents, surfactants, carriers, dispersants, thickeners, hydrophobizing agents, moisture-retaining agents, extenders, solid carriers, and anti-foaming agents.

21. The agricultural composition of claim 18, wherein the algae is selected from Spirulina, Chlorella, and mixtures thereof.

22. The agricultural composition of claim 21, wherein:
the osmoprotectants are selected from betaine, ectoine, trehalose, proline, lysine, glutamic acid, cysteine, and glycine;
the elicitors are selected from auxins, gibberellins, salicylic acid, methyl salicylate, jasmonic acid, benzoic acid, chitosan, beta-glucans, and carrageenans;
the binding agents are selected from arabic gum, xanthan gum, diutan gum, cellulose, alginates, carnauba wax, and candelilla wax; and
the auxiliaries are selected from emulsifiers, solvents, surfactants, carriers, dispersants, thickeners, hydrophobizing agents, moisture-retaining agents, extenders, solid carriers, and anti-foaming agents.

23. The agricultural composition of claim 18, wherein the agricultural composition is a liquid.

24. The agricultural composition of claim 18, wherein the agricultural composition has an algae concentration from 1 g/L to 500 g/L.

25. The agricultural composition of claim 18, comprising at least one osmoprotectant, wherein the agricultural composition has a concentration of osmoprotectant from 0.0001 g/L to 500 g/L.

26. The agricultural composition of claim 18, comprising at least one elicitor, wherein the agricultural composition has a concentration of elicitors from 0.0001 g/L to 500 g/L.

27. The agricultural composition of claim 18, wherein the algae comprises Spirulina platensis.

28. The agricultural composition of claim 18, comprising:
the algae or mixture of algae at a concentration from 1 g/L to 500 g/L;
at least one osmoprotectant at a concentration from 0.0001 g/L to 500 g/L, the at least one osmoprotectant being selected from betaine, ectoine, trehalose, proline, lysine, glutamic acid, cysteine, and glycine; and
at least one elicitor at a concentration from 0.0001 g/L to 500 g/L, the at least one elicitor being selected from auxins, gibberellins, salicylic acid, methyl salicylate, jasmonic acid, benzoic acid, chitosan, beta-glucans, and carrageenans.

29. The agricultural composition of claim 28, wherein the algae is selected from Spirulina, Chlorella, and mixtures thereof.

30. The agricultural composition of claim 28, wherein the algae comprises Spirulina platensis.

31. The agricultural composition of claim 18, wherein the agricultural composition is in the form of a powder or granules.

32. The agricultural composition of claim 18, wherein the crop is selected from fruits, vegetables, and arable crops.

33. The agricultural composition of claim 18, wherein the crop is selected from melons, apples, pears, mango, citrus, grapes, peaches, raspberries, gooseberries, cherries, kiwi, cucumbers, tomatoes, pumpkins, potatoes, sugar beets, corn, oilseed rape, cereals and soybeans.

34. A method for protecting crops against heat stress, the method comprising:
applying the agricultural composition according to claim 18 to the crops.

35. A kit, comprising:
a first container containing therein a liquid composition of an algae or a mixture of algae; and
a second container provided with the first container, the second container containing therein a powder or granular composition, the powder or granular composition comprising at least one ingredient selected from osmoprotectants, elicitors, binding agents, auxiliaries, and mixtures thereof.

36. The kit of claim 35, further comprising an agriculturally acceptable solvent or diluent.

37. A method for preparing a heat-stress protectant composition, the method comprising:
mixing a first composition with a second composition,
wherein:
the first composition is a liquid composition, a powder composition, or a granule composition and comprises an algae or a mixture of algae; and
the second composition is a liquid composition, a powder composition, or a granule composition and comprises at least one ingredient selected from osmoprotectants, elicitors, binding agents, auxiliaries, and mixtures thereof.
